(19) United States
(12) Patent Application Publication
(10) Pub. No.: US 2016/0218353 A1
(43) Pub. Date: Jul. 28, 2016

(54) METHOD FOR PREPARING METAL OXIDE-GRAPHENE NANOCOMPOSITE AND METHOD FOR PREPARING ELECTRODE USING METAL OXIDE-GRAPHENE NANOCOMPOSITE

(71) Applicant: AJOU UNIVERSITY INDUSTRY-ACADEMIC COOPERATION FOUNDATION, Suwon-si, Gyeonggi-do (KR)

(72) Inventors: Chang Koo KIM, Seoul (KR); Sang Wook KIM, Seoul (KR); Gyoung Hwa JEONG, Busan (KR); Hae Min LEE, Suwon-si (KR)

(73) Assignee: AJOU UNIVERSITY INDUSTRY-ACADEMIC COOPERATION FOUN DATION, Suwon-si, Gyeonggi-do (KR)

(21) Appl. No.: 14/917,198

(22) PCT Filed: Jul. 31, 2014
(86) PCT No.: PCT/KR2014/007016

§ 371 Date: Mar. 7, 2016

(30) Foreign Application Priority Data
Sep. 9, 2013 (KR) 10-2013-0107919

(51) Int. Cl. H01M 4/36; H01M 4/131; H01M 4/1391; H01M 4/1393; H01G 11/86; H01M 4/52; H01M 4/587; H01M 4/62; H01M 4/66; H01G 11/42; H01M 4/133; H01M 4/04

(52) U.S. Cl. CPC H01M 4/364; H01M 4/133; H01M 4/131; H01M 4/1391; H01M 4/1393; H01M 4/0404; H01M 4/0409; H01M 4/523; H01M 4/587; H01M 4/623; H01M 4/661; H01G 11/42; H01G 11/86

(57) ABSTRACT

Disclosed is a method of preparing a metal oxide-graphene nanocomposite, including preparing a nanocomposite material, forming graphene flakes by pretreating the nanocomposite material, and hydrothermally synthesizing the pretreated nanocomposite material. A method of manufacturing an electrode using the metal oxide-graphene nanocomposite is also provided. According to this invention, the metal oxide-graphene nanocomposite is synthesized from inexpensive graphite through one-step processing using only a surfactant, in place of conventional methods using oxidants, reductants and high-temperature heat, thereby lowering the number of processing steps and processing costs. Also, in the fabrication of the electrode, low electrical resistance characteristic of graphene is applied as it is, in place of the conventional use of active material, conductive material and binder, thereby exhibiting desired processing efficiency without the addition of the conductive material. Furthermore, highly pure graphene is prepared in a short time and various metal oxide active materials suitable for use in energy storage devices, for example, unary, binary, and multicomponent metal oxides, is formed through one-step processing, and necessary oxides having desired weight ratios {cobalt oxide (CoO), tricobalt tetraoxide (Co₃O₄), and cobalt hydroxide [Co(OH)₂]} can be easily prepared, and thus very wide application ranges (secondary batteries, gas sensors, etc.) are expected.

### TECHNICAL FIELD

The present invention relates to a method of preparing a metal oxide-graphene nanocomposite and a method of manufacturing an electrode using the metal oxide-graphene nanocomposite and, more particularly, to a method of preparing a metal oxide-graphene nanocomposite and a method of manufacturing an electrode using the metal oxide-graphene nanocomposite, wherein the metal oxide-graphene nanocomposite may be used as an electrode material for an energy storage device such as a capacitor or the like.

This invention is an offshoot of research performed as part of the Mid-Career Researcher Program (core research—individual), General Researcher Support Project—Basic Research Project supported by the Ministry of Science, ICT and Future Planning, the Ministry of Education, Science and Technology, and the National Research Foundation of Korea [Project Management Nos.: 2012R1A2A2A01004416 and 2013R1A1A2A10008031, Project Titles: Multi-directional slanted plasma etching for template-less direct patterning of three-dimensional high-aspect ratio microstructure, and Hybridization and application of nanoparticles/graphene].

### BACKGROUND ART

As electrode materials for secondary batteries these days, thorough research into metal oxides including graphene composites is ongoing thanks to active study on graphene and metal oxide nanocomposite materials.

Methods of manufacturing graphene films broadly include exfoliation from graphite (top-down approach) and chemical synthesis from carbon sources (bottom-up approach). Representative examples of the top-down approach include mechanical exfoliation from highly oriented pyrolytic graphite (HOPG), liquid-phase exfoliation for chemical separation through dispersion of graphite with a surfactant in a solution phase, and formation of graphene oxide/reduced graphene oxide (GO/rGO), including formation of GO through oxidation, dispersion thereof in a solution and then reduction thereof. Also, examples of the bottom-up approach include the formation of graphene on the surface of a metal catalyst using chemical vapor deposition (CVD) and the formation of graphene on the surface of silicon carbide (SiC) through pyrolysis.

Currently known methods of producing graphene mainly include oxidizing graphite powder to obtain graphite oxide, which is then subjected to physical heat such as microwaves or instant heat of 600° C. or higher to thus swell and exfoliate the layers for graphite. The produced graphene, which is in the form of graphene oxide, is added again with a reductant to prepare graphene. The reduced graphene oxide thus obtained suffers from having a remaining functional group such as an epoxy group of a chemical, which is not removed even by the reductant. Therefore, the purity of graphene is decreased, and additional processing therefor is required. Also, in order to form a graphene-metal oxide composite, metal oxide nanoparticles are made and then subjected to additional processing using an organic ligand.

As techniques for preparing metal-graphene nanocomposites from graphite, graphite oxide or graphene oxide is reduced and then metal nanoparticles are formed using a reductant, which is introduced in the following documents [D. R. Dreyer, S. Park, C. W. Bielawski and R. S. Ruoff, Chem. Soc. Rev., 2010, 39, 228; M. Feong, R. Sun, H. Zhan and Y. Chen, Nanotechnology, 2010, 21, 075601; J. Shen, B. Yan, H. Ma, N. Li and M. Ye, J. Mater. Chem., 2011, 21, 3415; T. S. Sreeprasad, S. M. Maliyekkal, K P. Lisha and T. Pradeep, J. Hazard. Mater., 2011, 186, 921; C. Xu, X. Wang and J. Zhu, J. Phys. Chem. C, 2008, 112, 19841; 3 R. Muszynski, B. Seger and P. V. Kamat, J. Phys. Chem. C, 2008, 112, 5263.]. As such, graphene is made and then metal nanoparticles are formed, and an organic ligand is used to link the metal nanoparticles and the reduced graphene oxide.

Such preparation methods are advantageous in terms of the size of nanoparticles and the dispersion uniformity, but are disadvantageous because the preparation process is complicated and it is difficult to maximize catalytic activity of the nanocomposite due to the presence of organic residue and the use of toxic reductant.

Also, techniques related to nanocomposites (nanocomposite products) are disclosed in Korean Patent No. 1110297 and Korean Patent Application Publication No. 2012-0113995.

Below is a brief description of a nanocomposite and a nanocomposite product disclosed in Korean Patent No. 1110297 and Korean Patent Application Publication No. 2012-0113995, respectively.

FIG. 1 is a flowchart illustrating the process of preparing the nanocomposite disclosed in Korean Patent No. 1110297 (hereinafter referred to as ‘Conventional Technique 1’). As illustrated in FIG. 1, the method of preparing the nanocomposite according to Conventional Technique 1 includes the first step of mixing carbon nanotubes with a urea solution, thus forming a urea/carbon nanotube composite, the second step of mixing the urea/carbon nanotube composite with a metal oxide or metal hydroxide precursor solution, thus preparing a precursor solution, and the third step of hydrolyzing the urea in the precursor solution, thus forming a metal oxide or metal hydroxide film on the carbon nanotubes.

FIG. 2 is a flowchart illustrating the process of preparing the nanocomposite product disclosed in Korean Patent Application Publication No. 2012-0113995 (hereinafter referred to as ‘Conventional Technique 2’). As illustrated in FIG. 2, the method of preparing the nanocomposite product according to Conventional Technique 2 includes the steps of reacting metal oxide with graphene to prepare a metal oxide/graphene precursor, and reacting the metal oxide/graphene precursor with a lithium ion solution, thus forming a lithium-containing metal oxide on the surface of graphene.

However, the nanocomposite and the nanocomposite product according to Conventional Techniques 1 and 2 are problematic because, in the course of adding the reductant or the like during the manufacture of graphene as described above, the reduced graphene oxide has a remaining functional group such as an epoxy group of a chemical, which is not removed even by the reductant.

### DISCLOSURE

### Technical Problem

Accordingly, the present invention has been made keeping in mind the above problems occurring in the related art, and an object of the present invention is to provide a method of preparing a metal oxide-graphene nanocomposite and a method of manufacturing an electrode using the metal oxide-graphene nanocomposite, in which the metal oxide-graphene nanocomposite, suitable for use in an electrode material for an energy storage device, may be hydrothermally synthesized through one-step processing from graphite using a surfactant and a metal oxide precursor, whereby a metal oxide-graphene nanocomposite electrode material having superior performance may be prepared in a short time.

Another object of the present invention is to provide a method of preparing a metal oxide-graphene nanocomposite and a method of manufacturing an electrode using the metal oxide-graphene nanocomposite, in which inexpensive graphite powder particles are used without change and which obviates an oxidant and a reductant, which are conventionally used, thus reducing the use of harmful reagents and the amount of processing impurities, thereby overcoming processing problems and decreasing processing costs, ultimately enabling the economical fabrication of the electrode.

### Technical Solution

In order to accomplish the above objects, the present invention provides a method of preparing a metal oxide-graphene nanocomposite, comprising: preparing a nanocomposite material; pretreating the nanocomposite material to form graphene flakes; and hydrothermally synthesizing the pretreated nanocomposite material.

In the present invention, preparing the nanocomposite material may include providing graphite powder, sodium hydroxide, sodium dodecyl sulfate, cobalt chloride hexahydrate as a metal precursor, and secondary distilled water.

In the present invention, in the nanocomposite material for synthesizing the metal oxide-graphene nanocomposite, sodium hydroxide may be replaced with potassium hydroxide or ammonium hydroxide.

In the present invention, in the nanocomposite material for synthesizing the metal oxide-graphene nanocomposite, sodium dodecyl sulfate may be replaced with any one selected from among dioctyl sodium sulfosuccinate, cetyl trimethyl ammonium bromide, cetrimonium chloride, and polyvinylpyrrolidone.

In the present invention, pretreating the nanocomposite material may include: immersing the graphite powder as the nanocomposite material, in distilled water, so that the graphite powder is sonicated, thus obtaining a sonicated graphite powder solution; adding a surfactant to the sonicated graphite powder solution; and subjecting the graphite powder solution to magnetic stirring at room temperature.

In the present invention, hydrothermally synthesizing the nanocomposite material may include: subjecting a graphene flake solution, a cobalt chloride solution and sodium hydroxide to magnetic stirring, thus obtaining a magnetically stirred solution; thermally reacting the magnetically stirred solution in a hydrothermal synthesis reactor, thus obtaining a thermally reacted product; washing the thermally reacted product; and drying the washed product.

In addition, the present invention provides a method of manufacturing an electrode using a metal oxide-graphene nanocomposite, comprising: grinding a metal oxide-graphene nanocomposite powder; mixing the powder with a predetermined synthetic resin dispersed in a binder, at a predetermined weight ratio, thus obtaining a mixture; subjecting the mixture to magnetic stirring; applying the mixture to a predetermined thickness; and drying the mixture applied to the predetermined thickness.

In the present invention, the synthetic resin may be polytetrafluoroethylene (PTFE).

In the present invention, the powder and the predetermined synthetic resin may be mixed at a weight ratio of 90:10.

### Advantageous Effects

According to the present invention, the metal oxide-graphene nanocomposite can be prepared from inexpensive graphite through one-step processing using only a surfactant, thus lowering the number of processing steps and decreasing processing costs, in place of conventional graphene synthesis methods using oxidants, reductants and high-temperature heat.

Also, according to the present invention, in the fabrication of the electrode, the low electrical resistance characteristic of graphene can be applied as it is, in place of the conventional use of active material, conductive material and binder, thereby exhibiting desired processing efficiency without the addition of the conductive material.

Also, according to the present invention, highly pure graphene can be prepared in a short time, and various metal oxide active materials suitable for use in energy storage devices, for example, unary, binary, and multicomponent metal oxides, can be formed through one-step processing, and furthermore, the necessary oxides having desired weight ratios {cobalt oxide (CoO), tricobalt tetraoxide (Co₃O₄), cobalt hydroxide [Co(OH)₂]} can be easily prepared, and thus very wide application ranges (secondary batteries, gas sensors, etc.) are expected.

### DESCRIPTION OF DRAWINGS

FIG. 1 is a flowchart illustrating the process of preparing a nanocomposite according to Conventional Technique 1;

FIG. 2 is a flowchart illustrating the process of preparing a nanocomposite product according to Conventional Technique 2;

FIG. 3 is a block diagram illustrating the process of preparing a metal oxide-graphene nanocomposite according to the present invention;

FIG. 4 is of a schematic view and a transmission electron microscope (TEM) image illustrating the synthesis of a cobalt oxide-graphene nanocomposite from graphite through the process of preparing a metal oxide-graphene nanocomposite according to the present invention;

FIG. 5 is a block diagram specifically illustrating the formation of graphene flakes in the process of preparing a metal oxide-graphene nanocomposite according to the present invention;

FIG. 6 is a block diagram specifically illustrating hydrothermal synthesis in the process of preparing a metal oxide-graphene nanocomposite according to the present invention;

FIG. 7 is a graph illustrating the X-ray diffraction (XRD) of the cobalt oxide-graphene nanocomposite obtained through the process of preparing a metal oxide-graphene nanocomposite according to the present invention;

FIG. 8 illustrates the Co(OH)₂/graphene TEM images of the cobalt oxide-graphene nanocomposite obtained through the process of preparing a metal oxide-graphene nanocomposite according to the present invention;

FIG. 9 is a block diagram illustrating the process of manufacturing an electrode using the metal oxide-graphene nanocomposite according to the present invention;

FIG. 10 is a charge-discharge graph of the cobalt oxide-graphene nanocomposite electrode obtained through the process of manufacturing an electrode using the metal oxide-graphene nanocomposite according to the present invention, in the potential range from −0.45 to 0.45 V in the electrolyte including the 2M KOH solution;

FIG. 11 is a graph illustrating the specific capacitance depending on the current density of the cobalt oxide-graphene nanocomposite electrode obtained through the process of manufacturing an electrode using the metal oxide-graphene nanocomposite according to the present invention, in the electrolyte including the 2M KOH solution; and

FIG. 12 is a graph illustrating the specific capacitance depending on the number of charge-discharge cycles of the cobalt oxide-graphene nanocomposite electrode obtained through the process of manufacturing an electrode using the metal oxide-graphene nanocomposite according to the present invention, in the electrolyte including the 2M KOH solution.

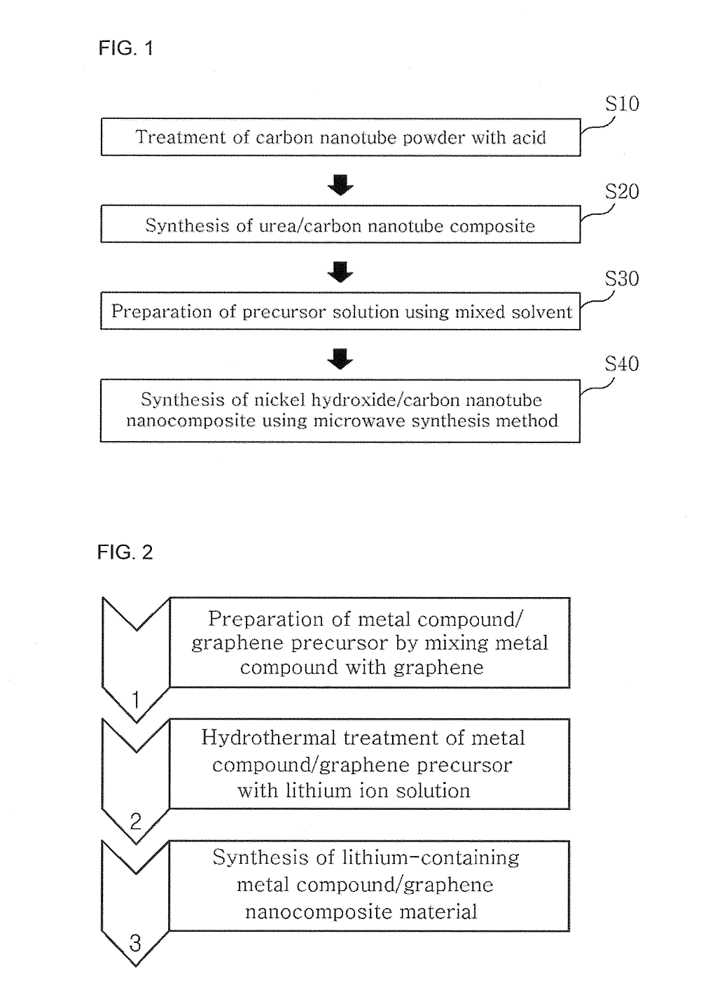

### BEST MODE

The present invention addresses a method of preparing a metal oxide-graphene nanocomposite, comprising: preparing a nanocomposite material; pretreating the nanocomposite material to form graphene flakes; and hydrothermally synthesizing the pretreated nanocomposite material.

Specifically, preparing the nanocomposite material may include providing graphite powder, sodium hydroxide, sodium dodecyl sulfate, cobalt chloride hexahydrate as a metal precursor, and secondary distilled water.

In the present invention, in the nanocomposite material for synthesizing the metal oxide-graphene nanocomposite, sodium hydroxide may be replaced with potassium hydroxide or ammonium hydroxide.

In the present invention, in the nanocomposite material for synthesizing the metal oxide-graphene nanocomposite, sodium dodecyl sulfate may be replaced with any one selected from among dioctyl sodium sulfosuccinate, cetyl trimethyl ammonium bromide, cetrimonium chloride, and polyvinylpyrrolidone.

In the present invention, pretreating the nanocomposite material may include: immersing the graphite powder as the nanocomposite material, in distilled water, so that the graphite powder is sonicated, thus obtaining a sonicated graphite powder solution; adding a surfactant to the sonicated graphite powder solution; and subjecting the graphite powder solution to magnetic stirring at room temperature.

In the present invention, hydrothermally synthesizing the nanocomposite material may include: subjecting a graphene flake solution, a cobalt chloride solution and sodium hydroxide to magnetic stirring, thus obtaining a magnetically stirred solution; thermally reacting the magnetically stirred solution in a hydrothermal synthesis reactor, thus obtaining a thermally reacted product; washing the thermally reacted product; and drying the washed product.

In addition, the present invention addresses a method of manufacturing an electrode using a metal oxide-graphene nanocomposite, comprising: grinding a metal oxide-graphene nanocomposite powder; mixing the powder with a predetermined synthetic resin dispersed in a binder, at a predetermined weight ratio, thus obtaining a mixture; subjecting the mixture to magnetic stirring; applying the mixture to a predetermined thickness; and drying the mixture applied to the predetermined thickness.

In the present invention, the synthetic resin may be polytetrafluoroethylene (PTFE).

In the present invention, the powder and the predetermined synthetic resin may be mixed at a weight ratio of 90:10.

### MODE FOR INVENTION

The terminologies or words used in the description and the claims of the present invention should be interpreted based on the meanings and concepts of the invention in keeping with the scope of the invention based on the principle that the inventors can appropriately define the terms in order to describe the invention in the best way.

As used herein, when any part “includes” any element, it means that the other elements are not precluded but are further included, unless otherwise mentioned. As also used herein, the “ . . . part” refers to a unit that processes at least one function or operation, and may be implemented by hardware, software, or a combination of hardware and software.

Hereinafter, a detailed description will be given of a metal oxide-graphene nanocomposite, a method of preparing the same, and a method of manufacturing an electrode using the metal oxide-graphene nanocomposite according to embodiments of the present invention with reference to the appended drawings.

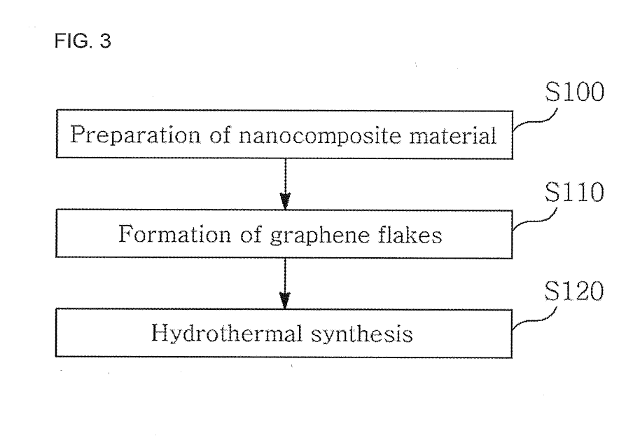

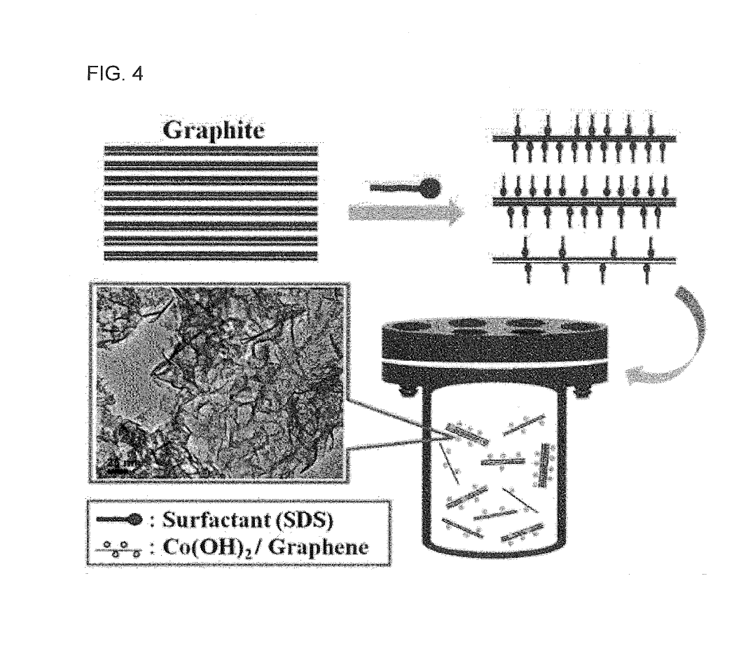

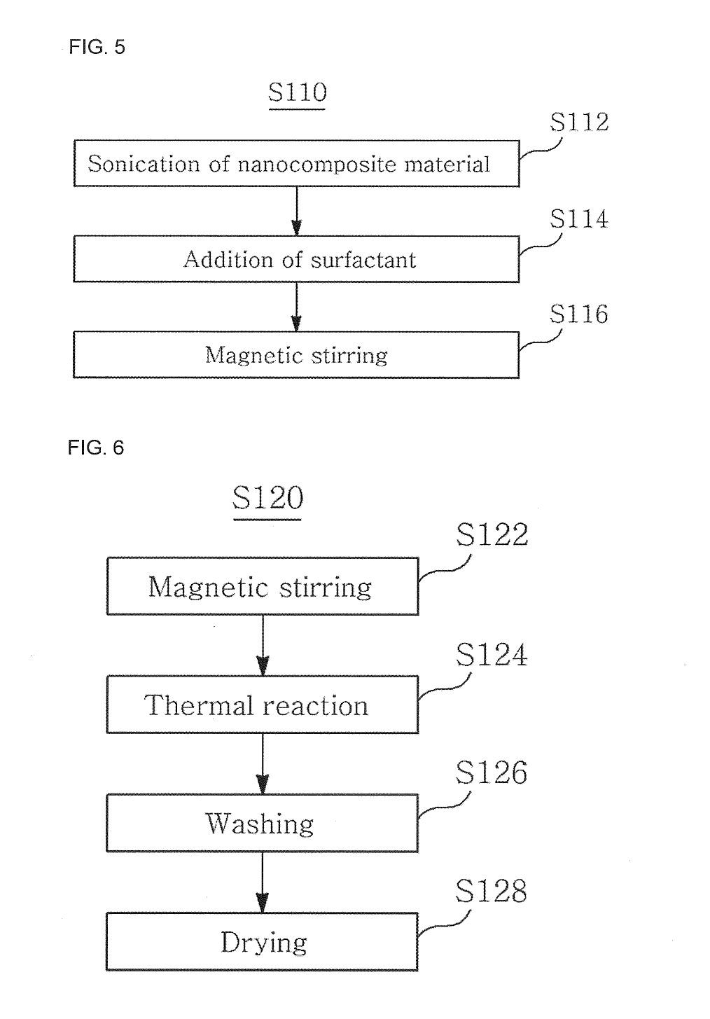

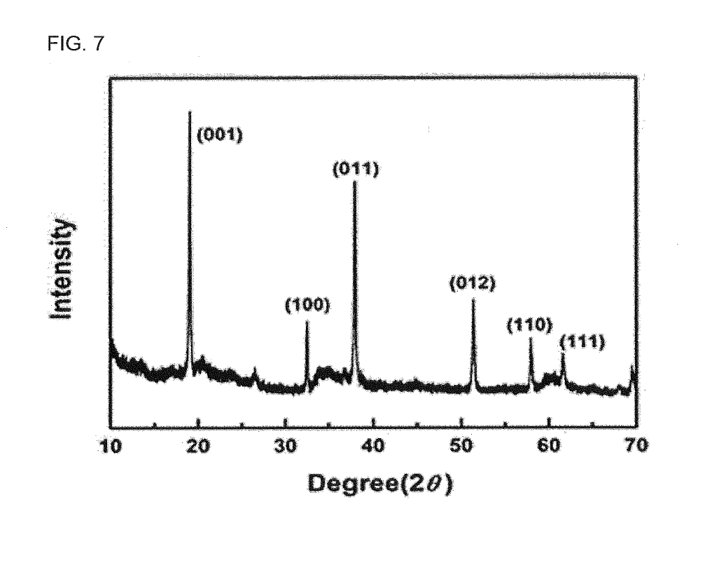

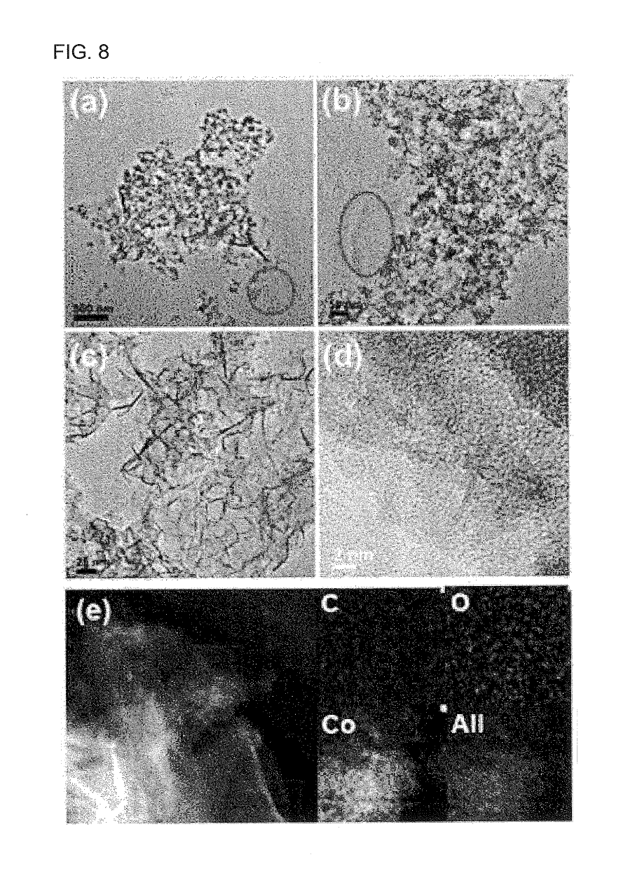

FIG. 3 is a block diagram illustrating the process of preparing a metal oxide-graphene nanocomposite according to the present invention, FIG. 4 is of a schematic view and a TEM image illustrating the synthesis of a cobalt oxide-graphene nanocomposite from graphite through the process of preparing a metal oxide-graphene nanocomposite according to the present invention, FIG. 5 is a block diagram specifically illustrating the formation of graphene flakes in the process of preparing a metal oxide-graphene nanocomposite according to the present invention, FIG. 6 is a block diagram specifically illustrating hydrothermal synthesis in the process of preparing a metal oxide-graphene nanocomposite according to the present invention, FIG. 7 is a graph illustrating XRD of the cobalt oxide-graphene nanocomposite obtained through the process of preparing a metal oxide-graphene nanocomposite according to the present invention, and FIG. 8 illustrates the Co(OH)₂/graphene TEM images of the cobalt oxide-graphene nanocomposite obtained through the process of preparing a metal oxide-graphene nanocomposite according to the present invention.

With reference to these drawings, the method of preparing the metal oxide-graphene nanocomposite according to the present invention includes the preparation of a nanocomposite material (S100), the formation of graphene flakes (S110), and hydrothermal synthesis (S120), the metal oxide-graphene nanocomposite being used as an electrode material for an electrochemical capacitor.

The preparation of the nanocomposite material (S100) is a step of preparing a nanocomposite material for synthesizing the metal oxide-graphene nanocomposite. The preparation of the nanocomposite material (S100) includes providing, as the nanocomposite material, graphite powder (the particle size of the powder is 1 to 20 μm), sodium hydroxide (NaOH, 98%), sodium dodecyl sulfate (SDS, 99+%), cobalt(II) chloride hexahydrate (CoCl₂6H₂O, 95%) as a metal precursor, and secondary distilled water.

In the nanocomposite material, sodium hydroxide may be replaced with potassium hydroxide (KOH, 85+%) or ammonium hydroxide (NH₄OH, 28%).

In the nanocomposite material, sodium dodecyl sulfate may be replaced with dioctyl sodium sulfosuccinate ((=AOT), 98%), cetyl trimethyl ammonium bromide ((=CTAB), 99%), cetrimonium chloride ((=CTAC), 98%), and polyvinylpyrrolidone ((=PVP), average mol wt 40,000).

The formation of the graphene flakes (S110) is a step of pretreating the nanocomposite material to form graphene flakes, and specifically includes sonicating the nanocomposite material (S112), adding a surfactant (S114), and performing magnetic stirring (S116).

Particularly, sonicating the nanocomposite material (S112) is a step of immersing 0.1 to 10 g of graphite powder, as the nanocomposite material, in 50 mL to 1 L of distilled water for 30 to 90 min (preferably 60 min) such that the graphite powder is sonicated. Thus, sonicating the nanocomposite material (S112) is performed to preliminarily separate the layers of graphite so as to facilitate the dispersion process upon adding the surfactant while decreasing the powder size in the sonication process.

Adding the surfactant (S114) is a step of adding 1 to 10 mM surfactant, namely sodium dodecyl sulfate (SDS), to the graphite powder solution obtained in the step of sonicating the nanocomposite material (S112).

Performing the magnetic stirring (S116) is a step of performing magnetic stirring using a magnetic stirrer (not shown) at room temperature for one day after adding the surfactant (S114), thereby forming graphene flakes.

After the formation of the graphene flakes (S110), the hydrothermal synthesis (S120) is carried out by means of a hydrothermal synthesizer (not shown) using the pretreated nanocomposite material, and specifically includes magnetic stirring (S122), thermal reaction (S124), washing (S126), and drying (S128).

The magnetic stirring (S122) is a step of subjecting 10 to 100 mL of a graphene flake solution, a 10 to 500 mM cobalt chloride solution, and 1.5 M sodium hydroxide to magnetic stirring in a beaker.

The thermal reaction (S124) is a step of thermally reacting the magnetically stirred solution, placed in a 50 mL Teflon liner hydrothermal reactor (not shown), in an oven at 50 to 300° C. for 1 to 24 hr, after the magnetic stirring (S122).

The washing (S126) is a step of washing the product obtained through thermal reaction, three or four times with distilled water and ethanol, 2 hr after the thermal reaction (S124).

The drying (S128) is a step of drying the product obtained through the washing (S126) in an oven at 40 to 60° C. (preferably 50° C.) for 5 to 7 hr (preferably 6 hr) to completely remove the water.

Therefore, the method of preparing the metal oxide-graphene nanocomposite according to the present invention enables the hydrothermal synthesis of metal oxide-graphene nanocomposite from inexpensive graphite through one-step processing using a surfactant and a metal oxide precursor without the use of an oxidant and a reductant, thus obtaining a metal oxide-graphene nanocomposite electrode material having superior performance in a short time. Although the conventional process is implemented in a manner in which graphene oxide is formed from graphite, reduced, and then linked with a ligand to make a composite, the formation of graphene oxide according to the present invention is simple.

Further, inexpensive graphite powder particles are used without change, and the use of harmful reagents and the amount of impurities attributable to conventional oxidation and reduction are decreased, thereby lowering the number of processing steps and processing costs.

When using the method of the invention, it is possible to manufacture an electrode comprising a nanocomposite of graphene and metal oxides of cobalt, manganese, nickel, tin, iron, iridium, or vanadium, suitable for use in the electrode active material for a secondary battery, such as a lithium ion battery, and a supercapacitor. Furthermore, a metal oxide-graphene nanocomposite having superior performance, including binary and ternary metal oxides such as cobalt-nickel, cobalt-manganese, etc., may be prepared in a short time. This is deemed to aid the fabrication of an electrode for an energy storage device, such as a lithium ion battery, as well as a supercapacitor.

In the Co(OH)₂/graphene TEM images of the nanocomposite of FIG. 8, the TEM images of Co(OH)₂/graphene of the synthesized nanocomposite are shown at different magnifications in FIGS. 8(a) to 8(c). FIGS. 8(a) and 8(b) show the appearance of graphene represented by the red circle, and FIG. 8(d) is a high resolution TEM (HR-TEM) in which the lattice distance (red line) is 0.236 nm.

This image shows that graphene is efficiently dispersed in the nanosheet. In the representative HAADF-STEM image seen in FIG. 8(e), Co, O and C components are uniformly distributed on the surface of the prepared graphene, thus forming a Co(OH)₂ nanosheet.

When mapping the red rectangular portion, which is not seen in the TEM image of FIG. 8(e), the C, O and Co components are sequentially layered and the lowest base is not present, thus causing irregular pressing or shrinking.

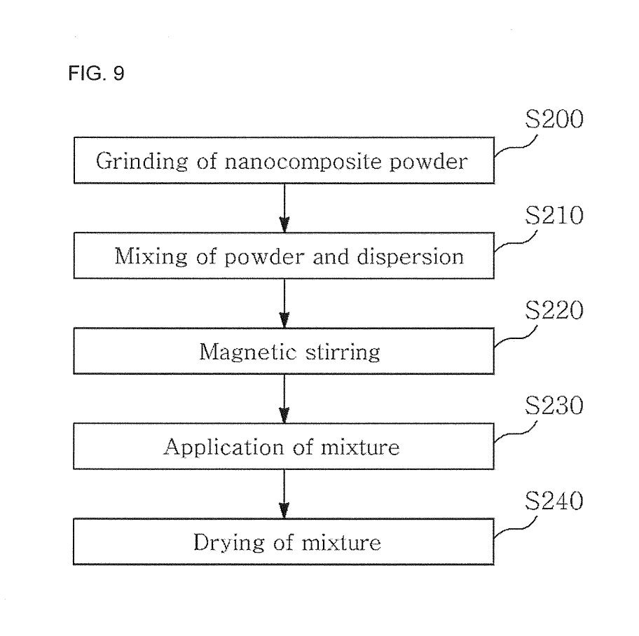

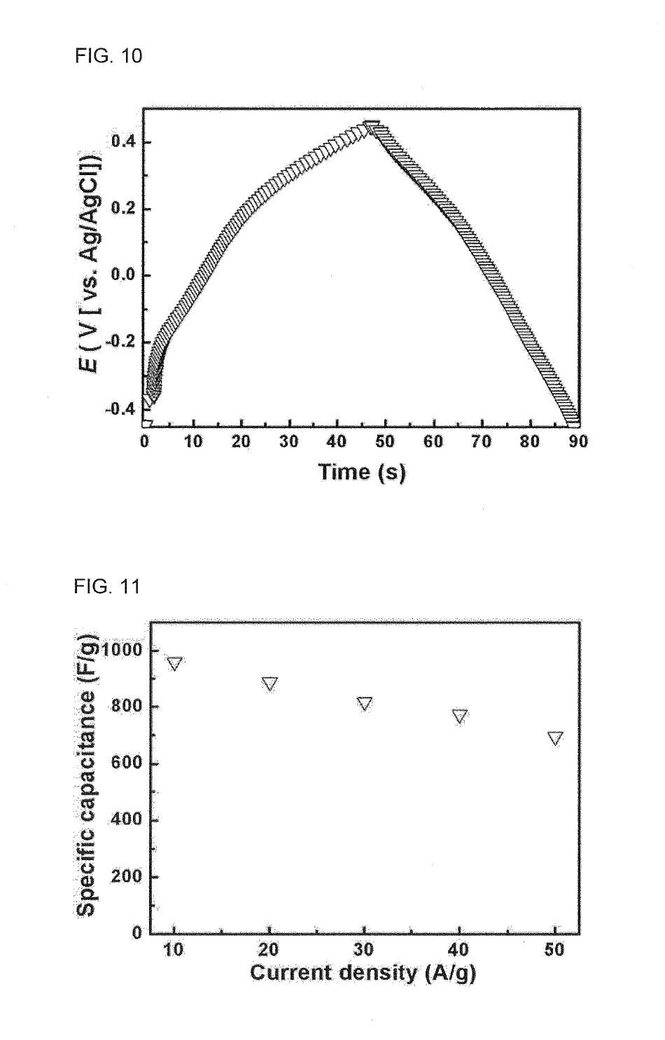

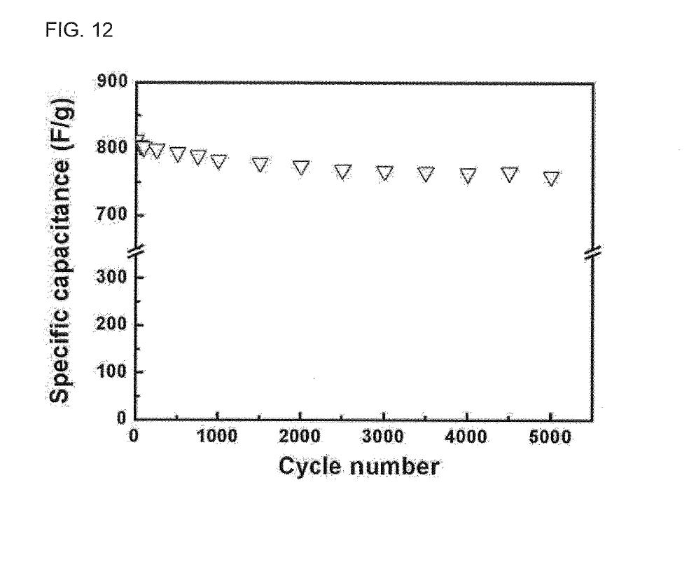

FIG. 9 is a block diagram illustrating the process of manufacturing an electrode using the metal oxide-graphene nanocomposite according to the present invention, FIG. 10 is a charge-discharge graph of the cobalt oxide-graphene nanocomposite electrode obtained through the process of manufacturing an electrode using the metal oxide-graphene nanocomposite according to the present invention, in the potential range from −0.45 to 0.45 V in the electrolyte including the 2M KOH solution, FIG. 11 is a graph illustrating the specific capacitance depending on the current density of the cobalt oxide-graphene nanocomposite electrode obtained through the process of manufacturing an electrode using the metal oxide-graphene nanocomposite according to the present invention, in the electrolyte including the 2M KOH solution, and FIG. 12 is a graph illustrating the specific capacitance depending on the number of charge-discharge cycles of the cobalt oxide-graphene nanocomposite electrode obtained through the process of manufacturing an electrode using the metal oxide-graphene nanocomposite according to the present invention, in the electrolyte including the 2M KOH solution.

With reference to these drawings, the method of manufacturing the electrode using the metal oxide-graphene nanocomposite according to the present invention includes grinding of nanocomposite powder (S200), mixing of the powder and a dispersion (S210), magnetic stirring (S220), application of a mixture (S230), and drying of the mixture (S240).

The grinding of the nanocomposite powder (S210) is a step of grinding the metal oxide-graphene nanocomposite powder in which the metal oxide-graphene nanocomposite powder obtained by the method of preparing the metal oxide-graphene nanocomposite is dried and then sufficiently ground using a mortar and pestle.

The mixing of the powder and the dispersion (S220) is a step of mixing the metal oxide-graphene nanocomposite powder with a specific synthetic resin, dispersed in a binder, at a predetermined weight ratio, after the grinding of the nanocomposite powder (S210). The mixing of the powder and the dispersion (S220) is performed in a manner in which the finely ground metal oxide-graphene nanocomposite powder and the specific synthetic resin, dispersed in 60 wt % in water as the binder, namely polytetrafluoroethylene (PTFE, 60 wt % dispersion in water), are mixed at a weight ratio of 90:10.

The magnetic stirring (S230) is a step of subjecting the mixture to magnetic stirring, after the mixing of the powder and the dispersion (S220).

The application of the mixture (S240) is a step of uniformly applying the mixture through rolling on a nickel foil 110 μm thick, after the magnetic stirring (S230). Here, the coating thickness is 40 to 60 μm (preferably about 50 μm).

The drying of the mixture (S250) is a step of drying the mixture applied to a predetermined thickness, after the application of the mixture (S240), and functions to dry, in an oven at 70 to 90° C. (preferably 80° C.) for 5 to 7 hr (preferably 6 hr), the electrode formed by the grinding of the nanocomposite powder (S210), the mixing of the powder and the dispersion (S220), the magnetic stirring (S230) and the application of the mixture (S240).

For a typical electrode active material [Co(OH)₂/graphene], a carbonaceous conductive material, such as acetylene black or Super P carbon black (MMMcarbon), is mixed to increase the electrical conductivity of the active material, and thus the electrode is formed of three components, namely the active material, the conductive material, and the binder. However, the active material according to the present invention, containing no conductive material, may advantageously exhibit performance equivalent to that when the active material, the conductive material and the binder are mixed at a weight ratio of 70:20:10.

Therefore, the performance of the electrode obtained through the method of manufacturing the electrode (S200) using the metal oxide-graphene nanocomposite according to the present invention may be measured using a standard three-electrode cell at room temperature. As such, the electrolyte used is a 2 M potassium hydroxide (KOH). A work electrode is connected to a 10×30 mm² sized cobalt oxide-graphene nanocomposite electrode (exposed area: 10×10 mm²), and an Ag/AgCl electrode is installed as a reference electrode. Provided as a counter electrode is a platinum-coated titanium mesh (2.5 cm²) electrode. In order to evaluate the electrode performance, constant current charge/discharge testing is performed. The charge/discharge testing is carried out in a manner in which complete discharge to −0.45 V is performed and measurement is then performed depending on the current density of 1 to 50 A/g (+ value upon charge, − value upon discharge) in the range of −0.45 to 0.45 V (vs. Ag/AgCl). The structural stability of the metal oxide electrode can be ensured despite the wide charge/discharge potential and large number of charge/discharge cycles (FIGS. 10 and 12).

FIG. 10 is a charge/discharge graph of the cobalt oxide-graphene nanocomposite electrode in the potential range of −0.45 to 0.45 V in the electrolyte including the 2M KOH solution. Here, the applied current density is 10 A/g, and the specific capacitance is 960 F/g.

FIG. 11 is a graph illustrating the specific capacitance depending on the current density of the cobalt oxide-graphene nanocomposite electrode in the electrolyte including the 2M KOH solution. As such, the current density varies in the range of 10 to 50 A/g. FIG. 12 is a graph illustrating the specific capacitance depending on the number of charge/discharge cycles of the cobalt oxide-graphene nanocomposite electrode in the electrolyte including the 2M KOH solution. As for electrode stability, re-stacking due to Van der Waals force did not occur in the graphene, and 93.2% of the initial specific capacitance was maintained even after 5000 charge/discharge cycles.

Additionally, in order to evaluate electrochemical properties using a computer-controlled potentiostat, testing was performed using a standard three-electrode cell at room temperature (23±1° C.). A saturated Ag/AgCl electrode and a platinum-coated titanium mesh (2.5 cm² in size) were used as the reference electrode and the counter electrode, respectively. A Co(OH)₂/graphene electrode having a size of 10×30 mm² (exposed area: 10×10 mm²) was used as the work electrode, and 2M KOH was used as the electrolyte. Before electrochemical analysis, the electrolyte was deaerated for 5 min using nitrogen gas. Cyclic voltammograms (CVs) were recorded in the range of −1.0 to 0.5 V. As such, the rate of scanning of AG/AgCl was 100 mV/s. The constant current charge/discharge reaction was carried out chrono-potentiometrically at a current varying in the range of 10 to 35 A/G. The electrode was discharged to −0.45 V (in the fully discharged state) in the first cycle, and discharged to 0.45 V (in the fully charged state) in the second cycle.

The capacitance (C) of the electrode may be calculated by the following Equation 1.

$$C = \frac{d Q}{d V} = \frac{{I}_{CONs}}{( d V \text{/} d t )} \qquad Equation 1$$

In this equation, Q is the electric charge of the electrode, I_{cons} is the constant current, and dV/dt was calculated from the slope of the discharge curve in Volts per second (V/S). The specific capacitance (F/G) of Co(OH)₂/graphene and Co(OH)₂/graphene mixed with the carbon electrode were obtained by dividing their respective weights.

Although the embodiments of the present invention have been disclosed with reference to the drawings, the present invention is not limited to such embodiments, and those skilled in the art will appreciate that various modifications and alterations are possible from the above description.

Therefore, the scope of the present invention should not be confined to the disclosed embodiments, and should be defined by the accompanying claims and equivalents thereto.

### INDUSTRIAL APPLICABILITY

The present invention pertains to a method of preparing a metal oxide-graphene nanocomposite and a method of manufacturing an electrode using the metal oxide-graphene nanocomposite. The method of preparing the metal oxide-graphene nanocomposite includes preparing a nanocomposite material, forming graphene flakes by pretreating the nanocomposite material, and hydrothermally synthesizing the pretreated nanocomposite material.

According to the present invention, the synthesis of the metal oxide-graphene nanocomposite from inexpensive graphite is possible through one-step processing using only a surfactant, in place of conventional graphene synthesis methods using oxidants, reductants and high-temperature heat. Thereby, the number of processing steps can be lowered and processing costs can be decreased. Also, in the fabrication of the electrode, the low electrical resistance characteristic of graphene can be applied as it is, in place of the conventional use of active material, conductive material and binder, thereby exhibiting desired processing efficiency without the addition of such a conductive material. Also, highly pure graphene can be prepared in a short time, and various metal oxide active materials suitable for use in energy storage devices, for example, unary, binary, and multicomponent metal oxides, can be formed through one-step processing, and furthermore, the necessary oxides having desired weight ratios {cobalt oxide (CoO), tricobalt tetraoxide (Co₃O₄), can cobalt hydroxide [Co(OH)₂]} can be easily prepared, and thus very wide application ranges (secondary batteries, gas sensors, etc.) are expected.

1. A method of preparing a metal oxide-graphene nanocomposite, comprising:
preparing a nanocomposite material;
pretreating the nanocomposite material to form graphene flakes; and
hydrothermally synthesizing the pretreated nanocomposite material,
wherein the preparing the nanocomposite material comprises providing graphite powder, sodium hydroxide, sodium dodecyl sulfate, cobalt chloride hexahydrate as a metal precursor, and secondary distilled water.

2. (canceled)

3. The method of claim 1, wherein in the nanocomposite material, the sodium hydroxide is replaced with potassium hydroxide or ammonium hydroxide.

4. The method of claim 1, wherein in the nanocomposite material, the sodium dodecyl sulfate is replaced with any one selected from among dioctyl sodium sulfosuccinate, cetyl trimethyl ammonium bromide, cetrimonium chloride, and polyvinylpyrrolidone.

5. The method of claim 1, wherein the pretreating comprises:
immersing the graphite powder as the nanocomposite material, in distilled water, so that the graphite powder is sonicated, thus obtaining a sonicated graphite powder solution;
adding a surfactant to the sonicated graphite powder solution; and
subjecting the graphite powder solution to magnetic stirring at room temperature.

6. The method of claim 1, wherein the hydrothermally synthesizing comprises:
subjecting a graphene flake solution, a cobalt chloride solution and sodium hydroxide to magnetic stirring, thus obtaining a magnetically stirred solution;
thermally reacting the magnetically stirred solution in a hydrothermal synthesis reactor, thus obtaining a thermally reacted product;
washing the thermally reacted product; and
drying the washed product.

7. A method of manufacturing an electrode using a metal oxide-graphene nanocomposite, comprising:
grinding a metal oxide-graphene nanocomposite powder;
mixing the powder with a predetermined synthetic resin dispersed in a binder, at a predetermined weight ratio, thus obtaining a mixture;
subjecting the mixture to magnetic stirring;
applying the mixture to a predetermined thickness; and
drying the mixture applied to the predetermined thickness.

8. The method of claim 7, wherein the synthetic resin is polytetrafluoroethylene (PTFE).

9. The method of claim 7, wherein the powder and the predetermined synthetic resin are mixed at a weight ratio of 90:10.
